(19) United States
(12) Patent Application Publication
(10) Pub. No.: US 2025/0388749 A1
(43) Pub. Date: Dec. 25, 2025

(54) THERMOPLASTIC POLYURETHANE (TPU) COMPOSITION WITH IMPROVED PROPERTIES

(71) Applicant: BASF SE, Ludwigshafen Am Rhein (DE)

(72) Inventors: Oliver Steffen HENZE, Lemfoerde (DE); Oliver MUEHREN, Lemfoerde (DE); Tanja LANGE, Lemfoerde (DE); Rebecca SPREEN, Lemfoerde (DE); Sabine MOELLER, Lemfoerde (DE)

(73) Assignee: BASF SE, Ludwigshafen Am Rhein (DE)

(21) Appl. No.: 18/879,003

(22) PCT Filed: Jun. 22, 2023
(86) PCT No.: PCT/EP2023/067019

§ 371 Date: Dec. 26, 2024

(30) Foreign Application Priority Data
Jun. 27, 2022 (EP) 22181299.3

(51) Int. Cl. C08L 75/04; C08K 3/32; C08K 5/05; C08K 5/053

(52) U.S. Cl. CPC C08L 75/04; C08K 3/32; C08K 5/05; C08K 5/053; C08K 2003/329

(57) ABSTRACT

The invention is directed to a thermoplastic polyurethane composition comprising polystyrene and a phosphorus containing flame retardant.

### BACKGROUND OF THE INVENTION

The current invention is directed to a thermoplastic polyurethane composition with improved mechanical, optical and sensory properties.

### DESCRIPTION OF RELATED ART

Thermoplastic polyurethanes are well known and applied in many fields due to their good mechanical properties, see e.g. EP 00617079 A1, EP 1167429 A1, WO 2015/128213, WO 2020/002200, WO 2022/058514, PCT/EP2021/087062, WO 2020/221786. Now in a lot of fields not only good mechanical properties are required, but more and more also haptic, visual, and sensory properties, are in the focus of the customer.

### SUMMARY OF THE INVENTION

### Problem

Now therefore the challenge of the current invention was to develop a new thermoplastic polyurethane which has good mechanical properties but at the same time fulfills the haptic, visual, and sensory requirements of the customer.

### Solution

It was surprisingly found that a thermoplastic polyurethane according to claim 1 fulfills these requirements.

### DETAILED DESCRIPTION OF THE INVENTION

In a first aspect and embodiment 1 the invention is directed to a thermoplastic polyurethane composition, wherein the thermoplastic polyurethane is the reaction product of at least the following building components, diisocyanate, polymer diol, chain extender, eventually in the presence of a catalyst, and the composition further comprises a polystyrene, a phosphorus containing flame retardant, and eventually additives and/or auxiliaries, wherein the polystyrene preferably is comprised in an amount between 0.5 wt % and 15 wt % referring to the whole amount of the composition The whole amount of the composition is referred to as 100 wt %.

The term composition indicates that the composition does not comprise the thermoplastic polyurethane only, but may comprise several polymers, additives and/or auxiliaries.

Preferably the thermoplastic polyurethane, is prepared by reacting an organic isocyanate, preferably an organic diisocyanate, with a compound reactive with isocyanate, in a preferred embodiment a polyol, preferably having two functional groups reactive with isocyanate, also referred to as polymer diol. The compound reactive with isocyanate preferably has a number average molecular weight of from 0.5×10³ g/mol to 100×10³ g/mol and, if desired, a chain extender preferably having a molecular weight of from 0.05×10³ g/mol to 0.499×10³ g/mol, preferably in the presence of a catalyst, an auxiliary, an additive, or a mixture thereof.

The components organic isocyanate, preferably diisocyanate, compound reactive with isocyanate, in a preferred embodiment polymer diol, and chain extender are also addressed individually or together as building components. The building components, if applicable, including the catalyst and/or the auxiliary and/or the additive are also called input materials. In order to adjust the hardness and melt flow index of the thermoplastic polyurethane (TPU), the molar ratios of the quantities of the building components and chain extender, can be varied, whereby the hardness and melt viscosity increase with increasing content of isocyanate or with increasing content of isocyanate and chain extender, while the melt flow index decreases.

In order to prepare the thermoplastic polyurethane, the building components isocyanate, polyol, and the chain extender, are reacted, in preferred embodiments in the presence of a catalyst, and optionally auxiliaries and/or additives, in such quantities that the equivalent ratio of NCO groups of the isocyanate, preferably the diisocyanate to the sum of the hydroxyl groups of the component reactive with isocyanate is 0.95:1 to 1.10:1, preferably 0.98:1 to 1.08:1 and in particular 1.0:1 to 1.05:1.

The thermoplastic polyurethane, preferably has a weight-average molecular weight of at least 0.04×10⁶ g/mol, more preferably at least 0.06×10⁶ g/mol, more preferably at least 0.07×10⁶ g/mol, and more preferably at least 0.08×10⁶ g/mol. The upper limit for the weight-average molecular weight of TPU is generally determined by the processability and the desired range of properties. Preferably the weight-average molecular weight does not exceed 0.5×10⁶ g/mol, more preferably 0.4×10⁶ g/mol, more preferably 0.25×10⁶ g/mol, and more preferably 0.2×10⁶ g/mol. The weight-average molecular weight as outlined herein preferably is determined by gel permeation chromatography, more preferably according to DIN 55672-1, where dimethylformamide (DMF) is used as solvent.

### Isocyanate

In a preferred embodiment 2 according to embodiment 1 or one of its preferred embodiments, the isocyanate comprises an organic isocyanate, more preferred a diisocyanate. Further preferred this isocyanate is selected from the group consisting of aliphatic, cycloaliphatic, araliphatic and aromatic isocyanates, or is a mixture thereof.

In a preferred embodiment 3 according to one of the precedent embodiments or one of their preferred embodiments, the isocyanate comprises an isocyanate selected from the group consisting of tri-, tetra-, penta-, hexa-, hepta- and/or octamethylene diisocyanate, 2-methyl-pentamethylene 1,5-diisocyanate, 2-ethyl-butylene-1,4-diisocyanate, 1,5-pentamethylene diisocyanate (PDI), 1,4-butylene-diisocyanate, 1-isocyanato-3,3,5-trimethyl-5-isocyanatomethyl-cyclohexane (isophorone diisocyanate, IPDI), 1,4-bis(isocyanatomethyl) cyclohexane and/or 1,3-bis(isocyanatomethyl) cyclohexane (HXDI), 2,4-paraphenylene diisocyanate (PPDI), 2,4-tetramethylene xylene diisocyanate (TMXDI), 4,4′-, 2,4′- and 2,2′-dicyclohexylmethane diisocyanate (H12MDI), 1,6-hexamethylene diisocyanate (HDI), 1,4-cyclohexane diisocyanate, 1-methyl-2,4- and/or -2,6-cyclohexane diisocyanate, 2,2′-diphenylmethane diisocyanate, 2,4′-diphenylmethane diisocyanate, 4,4′-diphenylmethane diisocyanate (MDI), 1,5-naphthylene diisocyanate (NDI), 2,4-toluene diisocyanate, 2,6-toluene diisocyanate (TDI), 3,3′-dimethyl-diphenyl diisocyanate, 1,2-diphenylethane diisocyanate, phenylene diisocyanate, or is a mixture thereof. Aliphatic isocyanates are preferred when stability against electromagnetic waves e.g. light is of importance, whereas aromatic polyisocyanate is preferred when high mechanical strength of the polyurethane, especially the thermoplastic polyurethane is required. A further advantage of aliphatic isocyanate is that it may be produced bio-based.

A very preferred aliphatic isocyanate is 1,5-pentamethylene diisocyanate. This has the additional advantage, that it can be produced bio based.

In a preferred embodiment 4 according to one of the precedent embodiments, or one of their preferred embodiments, the isocyanate comprises 2,2′-, 2,4′- or 4,4′-diphenylmethane diisocyanate (MDI), or a mixture thereof, especially preferred the isocyanate comprises 4,4′-diphenylmethane diisocyanate.

### Polyol

In a preferred embodiment 5 according to one of the precedent embodiments, or one of their preferred embodiments, the polyol has on statistical average at least 1.8 and at most 3.0 Zerewitinoff-active hydrogen atoms. This number is also referred to as the functionality of the isocyanate-reactive compound and indicates the quantity of the isocyanate-reactive groups of the molecule calculated theoretically down to one molecule from a quantity of substance. The functionality is preferred between 1.8 and 2.6, further preferred between 1.9 and 2.2 and especially preferred 2. Compounds reactive with isocyanates preferably have a number average molecular weight between 0.5×10³ g/mol and 8×10³ g/mol, more preferably between 0.7×10³ g/mol and 6.0×10³ g/mol, even more preferred between 0.8×10³ g/mol and 4.0×10³ g/mol.

Preferably the polyol is linear and is a single polyol or is a mixture of different polyols, in which case the mixture meets the above requirements.

The polyol preferably is selected from the group consisting of polyesterols, polyetherols or polycarbonate diols, or is a mixture thereof. More preferred the polyol is selected from the group consisting of polyether diol and polycarbonate diol. Particularly preferred the polyol is polyether diol.

### Polyetherpolyol

In a preferred embodiment 6 according to one of the precedent embodiments, or one of their preferred embodiments, the polyol comprises a polyether polyol, preferably a polyether diol, further preferred the polyether diol is based on ethylene oxide, propylene oxide and/or butylene oxide unites, or a mixture thereof.

More preferred the polyether polyol comprises polytetramethylene ether glycol (also referred as PTMEG or PTHF), poly 1,3-propanediol, or poly 1,4-butanediol, or is a mixture thereof. Particularly preferred is PTHF.

In a preferred embodiment 7 according to one of the precedent embodiments or one of their preferred embodiments the polyetherpolyol has a number average molecular weight between 0.6×10³ g/mol and 2.0×10³ g/mol, preferably between 0.8×10³ g/mol and 1.9×10³ g/mol, more preferably with a number average molecular weight between 0.8×10³ g/mol and 1.2×10³ g/mol, or between 1.3×10³ g/mol and 1.9×10³ g/mol, and most preferably 1.0×10³ g/mol or 1.4×10³ g/mol.

The number average molecular weight Mn in the context of this invention is preferably determined according to DIN 55672-1.

A very preferred polyether polyol is polytetrahydrofuran (PTHF), preferably with the molecular weight as indicated above for the polyetherpolyol.

Polyether polyols are obtained by known methods, such as but not limited to, reaction between at least one starter molecule, such as ethylene glycol, propylene glycol, and alkylene oxide such as ethylene oxide, propylene oxide, mixtures of ethylene oxide and propylene oxide or derive from tetrahydrofuran.

In another preferred embodiment 8 according to one of the precedent embodiments or one of their preferred embodiments the 1,3-propanediol, the poly 1,4-butanediol diol, or a mixture thereof has a number average molecular weight between 1.2×10³ g/mol and 1.8×10³ g/mol, more preferred between 1.3×10³ g/mol and 1.5×10³ g/mol, most preferred 1.4×10³ g/mol. In a preferred embodiment the polyol is a mixture of a poly-butane-1,4-diol with a molecular weight of 1.0×10³ g/mol and 2.0×10³ g/mol.

Polyetherpolyol has the advantage that it is more stable against hydrolysis and thus will be applied in applications where this is a requirement

### Polyester Polyol

In a preferred embodiment 9 according to one of the precedent embodiments or one of their preferred embodiments the polyol comprises a polyester polyol. Preferably the polyester is selected from the group consisting of reaction product of polyhydric alcohol, polymerization product of lactone and polymerization product of di-carboxylic acids with polyhydric alcohols. The term “lactone” refers to cyclic esters of hydroxycarboxylic acids. Such polyester polyols include hydroxyl-terminated reaction products of polyhydric alcohols, polyester polyols obtained as the polymerization product of lactone, e.g. caprolactone, in conjunction with a polyol, and polyester polyols obtained by the polymerization of a di-carboxylic acid, e.g. adipic acid, with a polyhydric alcohol. Preferred polyester polyols include polymerization product of lactone or polycaprolactone and the ones obtained by the polymerization of a di-carboxylic acid with a polyhydric alcohol.

Preferably the polyester polyol is obtained by polymerizing a di-carboxylic acid with a polyhydric alcohol. Preferred di-carboxylic acid is at least one of C4 to C12 dicarboxylic acid, while at least one of C2 to C14 diol are suitable as polyhydric alcohols. Preferably the C4 to C12 dicarboxylic acid is selected from the group consisting of an aliphatic dicarboxylic acid preferably selected from succinic acid, glutaric acid, adipic acid, suberic acid, azelaic acid and sebacic acid, or is a mixture thereof, and an aromatic dicarboxylic acid, preferably selected from phthalic acid, isophthalic acid and terephthalic acid, or a mixture thereof. More preferably, the dicarboxylic acid is selected from the group consisting of succinic acid, glutaric acid, adipic acid, suberic acid, phthalic acid, isophthalic acid and terephthalic acid, or is a mixture thereof. Most preferably, the dicarboxylic acid it is selected from the group consisting of adipic acid, suberic acid and phthalic acid, or a is a mixture thereof.

Preferably, C2 to C14 diol used for obtaining the polyester polyol is selected from the group consisting of ethylene glycol, diethylene glycol, 1,4-butanediol, 1,5-pentanediol, 1,6-hexanediol, 1,10-decanediol, 2,2-dimethyl-propane-1,3-diol, 1,3-propanediol, 2-methyl-1,3-propanediol and di-propylene glycol, or is a mixture thereof. More preferably, the diol is selected from the group consisting of ethylene glycol, diethylene glycol, 1,4-butanediol, 1,5-pentanediol, 1,6-hexanediol, 1,10-decanediol or a mixture thereof. Most preferably, it is selected from the group consisting of 1,4-butanediol, 1,5-pentanediol, 1,6-hexanediol, 1,10-decanediol, or is a mixture thereof.

Polyester polyols have less stability against hydrolysis and are preferred in applications where biodegradability is required.

### Polycarbonat Diol

In a preferred embodiment 10 according to one of the precedent embodiments, or one of their preferred embodiments, the polyol comprised a polycarbonate diol, preferably an aliphatic polycarbonate diol. Preferred polycarbonate diols are polycarbonate diols based on alkane diols. The production of polycarbonate diols can be carried out by polycondensation of phosgene with diols or by ring-opening polymerization of cyclic carbonates. As a preferred alternative to phosgene synthesis, a transesterification with carbonic acid diesters is applied.

Preferred polycarbonate diols are strictly OH-difunctional polycarbonate diols, preferably strictly OH-difunctional aliphatic polycarbonate diols. Preferred polycarbonate diols are based on butanediol, pentanediol or hexanediol. In particular polycarbonate diols are based on 1,4-butanediol, 1,5-Pentanediol, 1,6-Hexanediol, 3-Methylpentane-(1,5)-diol, or are mixtures thereof. More preferred polycarbonate diols are based on 1,4-butanediol, 1,5-pentanediol, 1,6-hexanediol, or mixtures thereof. More preferred are polycarbonate diols based on butanediol and hexanediol, polycarbonate diols based on pentanediol and hexanediol, polycarbonate diols based on hexanediol, or mixtures thereof.

Preferably, the polycarbonate diol has a number average molecular weight Mn in the range from 0.5×10³ to 4.0×10³ g/mol, preferably in the range from 0.65×10³ g/mol to 3.0×10³ g/mol, preferred in the range from 0.8×10³ g/mol to 2.5×10³ g/mol, more preferred the number average molecular weight is between 1.8×10³ g/mol and 2.2×10³ g/mol or between 0.8×10³ g/mol and 1.2×10³ g/mol.

Polycarbonate diols have better permeability for microwave, less dirt uptake and show better flame retardancy.

### Mixture of Polyol

In one preferred embodiment the polyol is a single polyol, in another preferred embodiment the polyol is a mixture of two or more polyols as preferred above.

In a preferred embodiment 11 according to one of the precedent embodiments, or one of their preferred embodiments, the polyol is a mixture of at least one polyether polyol and at least one polycarbonate diol.

In a mixture of a polyether polyol and a polycarbonate diol, the polycarbonate diol preferably is used in an amount of less than 50% by weight, preferably less than 30% by weight based on the total weight of the polyol.

### Chain Extender

Further a chain extender is used in the synthesis of the thermoplastic polyurethane. In a preferred embodiment 12 according to one of the precedent embodiments, or one of their preferred embodiments the chain extender comprises an aliphatic, araliphatic, aromatic and/or cycloaliphatic compound. Preferably the chain extender has a number average molecular weight of 0.05×10³ g/mol to 0.499×10³ g/mol. The chain extender preferably has 2 groups reactive with isocyanate. These groups are also referred to as functional groups. The chain extender is either a single chain extender or a mixture of at least two chain extenders.

In a preferred embodiment 13 according to one of the precedent embodiments, or one of their preferred embodiments the chain extender is a difunctional compound, preferred examples being diamines or alkane diols, preferably having 2 to 10 carbon atoms in the alkylene radical, or a mixture thereof.

In a preferred embodiment 14 according to one of the precedent embodiments, or one of their preferred embodiments the chain extender is selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, di-, tri-, tetra-, penta-, hexa-, hepta-, okta-, nona- and/or deca alkylene glycole dipropylene glycol, 1,4-cyclohexanediol, 1,4-dimethanol cyclohexane, neopentylglycol and hydroquinone bis (beta-hydroxyethyl) ether (HQEE), or is a mixture thereof.

More preferably the chain extender selected from the group consisting of 1,2-ethylene glycol, 1,3-propanediol, 1,4-butanediol, and 1,6-hexanediol, di-, tri-, tetra-, penta-, hexa-, hepta-, okta-, nona- and/or deca alkylene glycole, preferably respective oligo- and/or polyalkylene glycole, or is a mixture thereof.

In one preferred embodiment 15 according to one of the precedent embodiments or one of their preferred embodiments the chain extender comprises 1,2-ethylenediol, 1,3-propanediol, 1,4-butanediol or 1,6-hexanediol, or a mixture thereof, most preferably the chain extender comprises 1,4-butane diol.

### Catalyst

In a preferred embodiment 16 according to any of the precedent embodiments or one of their preferred embodiments, the composition further comprises a catalyst. The catalyst is either a single catalyst or is a mixture of several catalysts.

The catalysts preferably accelerate the reaction between the NCO groups of the isocyanates and the hydroxyl groups of the polyol and of the chain extender. In a preferred embodiment the catalyst is selected from the group consisting of a tertiary amine and an organic metal compound or is a mixture thereof.

A preferred organic metal compound is selected from the group consisting of titanic ester, iron compound, tin compound, and bismuth salt, or is a mixture thereof. A preferred iron compound is iron (III) acetylacetonate. A preferred tin compound is selected from the group consisting of tin diacetate, tin dioctoate, tin dilaurate, tin (II) neodecanoate, and dialkyl tin salts of aliphatic carboxylic acids, or a mixture thereof. Preferably the catalyst is tin dioctoate, tin (II) neodecanoate, or is a mixture thereof. A preferred titanic ester is tetrabutyl orthotitanate. In preferred bismuth salts, the bismuth is present in the oxidation states 2 or 3, in particular 3, with preference being given to salts of carboxylic acids, preferably carboxylic acids having from 6 to 14 carbon atoms, particularly preferably from 8 to 12 carbon atoms. A very preferred bismuth salt is bismuth (III) neodecanoate, bismuth 2-ethylhexanoate, or bismuth octanoate, or is a mixture thereof.

The catalyst is preferably used in an amount of from 0.0001 to 0.1 part by weight per 100 parts by weight of the polyol. Preference is given to using tin catalyst, in particular tin dioctoate.

In a preferred embodiment 17 according to any of the precedent embodiments or one of their preferred embodiments, the composition comprises SDO (tin (II) 2-ethylhexanoate), tin (II) neodecanoate, or a mixture thereof, preferably used in quantities of 0.35-0.4 parts per weight, referring to the whole composition.

The catalyst is either a single substance or a mixture of at least two substances.

### Auxiliary

In preferred embodiment 18 according to one of the precedent embodiments or on of its preferred embodiments, an auxiliary or additive is comprised in the composition. The additive or auxiliary is either a single substance or a mixture of at least two substances. Preferred examples include a surface-active substance, a filler, a flame retardant, a nucleating agent, an oxidation stabilizer, a lubricating aid, a demolding aid, a dye, a pigment, an inorganic filler an or organic filler, a reinforcing agent, a plasticizer, an antistatic agent, a stabilizer, preferably a stabilizer against hydrolysis, light, heat or discoloration.

Stabilizer in the sense of this invention is an additive which protects a plastic or a plastic composition against harmful environmental influences. A preferred example is a primary or secondary antioxidant, a sterically hindered phenol, a hindered amine light stabilizer, an UV absorber, a phosphite, a hydrolysis inhibitor, a quencher, and a flame retardant. Examples of commercial stabilizers are given in Plastics Additives Handbook, 5th Edition, H. Zweifel, ed., Hanser Publishers, Munich, 2001 ([1]), p. 98-S136.

Preferably the UV absorber has a number average molecular weight greater than 0.3×10³ g/Mol, in particular greater than 0.39×10³ g/Mol. Furthermore, the preferred UV absorber has a molecular weight not exceeding 5×10³ g/Mol.

The UV absorber is preferably selected from the group consisting of cinnamates, oxanilides, benzophenones and benzotriazole, or is a mixture thereof, particularly suitable as UV absorbers is benzotriazole. Examples of particularly suitable UV-absorbers are Tinuvin® 213, Tinuvin® 234, Tinuvin® 312, Tinuvin® 571, Tinuvin® 384 and Eversorb® 82.

Preferably the UV absorbers is added in quantities of 0.01 wt. % to 5 wt. % based on the total weight of the composition, preferably 0.1 wt. % to 2.0 wt. %, in particular 0.2 wt. % to 0.5 wt. %.

Often a UV stabilization based on an antioxidant and a UV absorber as described above is not sufficient to guarantee a good stability of the composition against the harmful influence of UV rays. In this case, in addition to the antioxidant and/or the UV absorber, or as single stabilizer, a hindered-amine light stabilizer (HALS) is added to the composition.

Examples of commercially available HALS stabilizers can be found in Plastics Additive Handbook, 5th edition, H. Zweifel, Hanser Publishers, Munich, 2001, pp. 123-136.

Particularly preferred hindered amine light stabilizers are bis-(1,2,2,6,6-penta-methylpiperidyl) sebacat (Tinuvin® 765, Ciba Spezialitätenchemie AG) and the condensation product of 1-hydroxyethyl-2,2,6,6-tetramethyl-4-hydroxypiperidine and succinic acid (Tinuvin® 622). In particular, the condensation product of 1-hydroxyethyl-2,2,6,6-tetramethyl-4-hydroxypiperidines and succinic acid (Tinuvin® 622) is preferred, if the titanium content of the finished product is less than 150 ppm, preferably less than 50 ppm, in particular less than 10 ppm, based on the components used.

HALS compounds are preferably used in a concentration of from 0.01 wt. % to 5 wt. %, particularly preferably from 0.1 wt. % to 1 wt. %, in particular from 0.15 wt. % to 0.3 wt. %, based on the total weight of the composition.

A particularly preferred UV stabilizer contains a mixture of a phenolic stabilizer, a benzotriazole and a HALS compound in the preferred amounts described above.

Further information on the above-mentioned auxiliaries and additives can be found in the technical literature, e.g. Plastics Additives Handbook, 5th edition, H. Zweifel, ed., Hanser Publishers, Munich, 2001.

### Polystyrene

It was surprisingly found that adding polystyrene to a composition comprising thermoplastic polyurethane tarnishes the surface of the composition and by this, scratches and the like do not shine out that much, which is a huge advantage for the customer.

In preferred embodiment 19 according to one of the precedent embodiments or one of their preferred embodiments, the polystyrene is comprised in an amount between 0.5 wt % and 15 wt %, mor preferred between 0.5 wt % and 7 wt %, referring to the whole amount of the composition The whole amount of the composition is 100 wt %.

Preferred polystyrene is impact polystyrene copolymer based on the monomers styrene and butadiene.

In a preferred embodiment the polystyrene fulfills at least one of the following properties, most preferably all the following properties.

Preferably the impact polystyrene copolymer has an elastic modulus of 1500 to 3300 N/mm², preferably measured according to DIN 53 457, preferably between 1700 and 2500 N/mm². The tensile strength of the polystyrene copolymer preferably is between 18 and 35 of, preferably from 20 to 26 N/mm², preferably measured according to DIN 53 455.

The tear elongation of the polystyrene preferably is between 30% and 55%, preferably measured according to DIN 53 455, more preferably from 40% to 50%.

The impact strength (charpy) at −40° C. of the polystyrene, preferably is between 50 KJ/m² and 100 KJ/m², preferably measured according to DIN 53 453, preferably from 60 KJ/m² to 70 KJ/m². The Vicat softening temperature of the polystyrene preferably is between 75° C. and 97° C., preferably measured according to DIN 53 460 VTS/A/50, preferably from 80 to 90 [° C.].

In a preferred embodiment 20 according to one of the precedent embodiments or one of their preferred embodiments, the composition comprises a derivate of kresol, phenol, piperazine, resorcinol, bisphenole A, or a mixture thereof.

### Flame Retardant

The composition according to any of the precedent embodiments or one of their preferred embodiments further comprises a phosphorus containing flame retardant.

The flame retardant is used in the form of single substance or in mixtures of several substances of either the same kind of flame retardants or different kinds of flame retardants in the composition. In a preferred embodiment the flame retardant is liquid, preferably liquid at a temperature of 21° C. In a preferred embodiment liquid has a viscosity at 25° C. between 1 mPas and 1×10³ mPas, preferably between 1 mPas and 3×10³ mPas, more preferably between 5 mPas and 1×10³ mPas, more preferably between 3×10 mPas and 0.8×10³ mPas, more preferably between 3,5×10² mPas and 8×10² mPas. The viscosity preferably is the dynamic viscosity.

In a preferred embodiment 21 according to one of the precedent embodiments or one of their preferred embodiments the phosphorus containing flame retardant is a derivative of the phosphorus acid, of the phosphonic acid, or of the phosphinic acid, or is a mixture thereof.

In a preferred embodiment 22 according to one of the precedent embodiments or one of their preferred embodiments, the phosphorus containing flame retardant is comprised in the composition with an amount between 5 weight-% and 40 weight-%, more preferably between 10 weight-% and 30 weight-%. If no further non phosphorous containing flame retardant is present in the composition, the amount of the phosphorus containing flame retardant in the composition preferably is between 15 weight-% and 30 weight-%.

Preferably the flame retardant has an average particle diameter D50 in the range between 0.1 μm and 100 μm, preferably between 0.5 μm and 60 μm, particularly preferably between 3 μm and 50 μm. The particles preferably have an average particle diameter D99 of less than 100 μm, more preferably of less than 90 μm. In the context of the present invention the flame retardant preferably has an average particle diameter D50 in the range from 0.1 μm to 100 μm and an average particle diameter D99 of less than 100 μm. In the context of the present invention the particle size distribution may be monomodal or else multimodal, more preferred bimodal.

### Phosphoric Acid Ester

The phosphoric acid ester preferably is a tri-ester, more preferred a trialkyl phosphate. Other preferred phosphoric acid esters are triaryl phosphates, more preferred triphenyl phosphate.

In a preferred embodiment 23 according to one of the precedent embodiments or one of their preferred embodiments the phosphoric ester has the general formula (I)

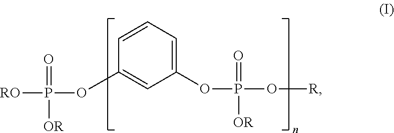

where R denotes substituted alkyl, cycloalkyl, or phenyl groups, and n is an integer in the range from 1 to 15.

If R in the general formula (I) is an alkyl moiety, alkyl moieties that preferably are used are those having from 1 to 8 carbon atoms. The cyclohexyl is a preferred example of the cycloalkyl groups. In other preferred embodiments R denotes a phenyl or alkyl-substituted phenyl. Preferably, n is 1, or an integer from 3 to 6.

In a preferred embodiment 24 according to one of the precedent embodiments or one of their preferred embodiments the phosphoric acid ester is selected from the group consisting of resorcinol bis-diphenyl phosphate (RDP), bisphenol-A bis-(diphenyl phosphate) (BDP), and diphenylkresyl phosphate (DPK), or is a corresponding oligomer, or is a mixture thereof. The oligomer preferably has an average degree of oligomerization of n=3 to 6.

Most preferred the flame retardant comprises resorcinol bis-diphenyl phosphate (RDP), more preferred in the form of an oligomer with an average degree of oligomerization of n=3 to 6. The phosphoric acid derivate preferably is comprised in an amount of between 1% by weight and 25% by weight referring to the whole composition, preferably between 2% by weight and 12% by weight, most preferably between 2% by weight and 6% by weight.

These flame retardants are especially advantageous since they are liquid at room temperature and therefor are better processable and in addition show a plasticizer effect in the composition, which is especially preferred, when the composition shall be flexible.

### Phosphinate

In a preferred embodiment 25 of the composition according to one of the precedent embodiments, or one of their preferred embodiments, the flame retardant comprises a derivative of the phosphinic acid.

Preferably the derivative of phosphinic acid is selected from salts of the phosphinic acid comprising an organic or inorganic cation or from organic esters, or is a mixture thereof. Phosphinic esters have the general formula R1R2(P═O)OR3, wherein all three organic groups R1, R2 and R3 may be identical or different. The radicals R1, R2 and R3 are either aliphatic or aromatic and preferably have 1 to 20 carbon atoms, more preferably 1 to 10, more preferably 1 to 3. Preferably at least one of the radicals is aliphatic, preferably all of the radicals are aliphatic, very particularly preferably R1 and R2 are ethyl radicals. It is more preferable when R3 too is aliphatic and more preferably an ethyl radical or a methyl radical. In a preferred embodiment R1, R2 and R3 are simultaneously ethyl radicals or methyl radicals.

Other preferred derivatives of the phosphinic acid are phosphinates, i.e. the salts of phosphinic acid with the general formula: R1R2(P═O)O⁻Me⁺. The R1 and R2 radicals are either aliphatic or aromatic. Further preferred R1 and R2 independently have 1 to 20 carbon atoms, preferably 1 to 10, more preferably 1 to 3. Preferably at least one of the R1 or R2 radical is aliphatic, preferably both radicals are aliphatic, e. Met preferably is an alkali metal or alkaline earth metal, or a mixture thereof, more preferably Met is aluminum, calcium or zinc, or is a mixture thereof, more preferably Met is aluminum or zinc, or is a mixture thereof, most preferably Me⁺ is aluminium.

Other preferred derivatives of the phosphinic acid are metal hypophosphite salts with the general formula: H₂(P═O)O⁻Me⁺, preferably Met is an alkali metal or alkaline earth metal, or a mixture thereof, preferably Met is aluminium, titanium, or zinc, or a mixture thereof. A particularly preferable salt is aluminum hypophosphite, or calcium hypophosphite, or a mixture thereof, most preferred is aluminium hypophosphite.

In a preferred embodiment 26 of the compositions according to one of the precedent embodiments or one of their preferred embodiments, the flame retardant comprises diethyl aluminum phosphinate and a derivative of the phosphoric acid as preferred above, more preferred the derivative of the phosphoric acid is selected from the group consisting resorcinol bis-diphenyl phosphate (RDP), bisphenol-A bis-(diphenyl phosphate) (BDP), and diphenylkresyl phosphate (DPK), or is a corresponding oligomer, or is a mixture thereof. The oligomer preferably has an average degree of oligomerization of n=3 to 6.

In a preferred embodiment 27 according to one of the precedent embodiments or one of their preferred embodiments, the flame retardant comprises diethyl aluminum phosphinate and resorcinol bis (diphenyl phosphate) (RDP), more preferred the RDP in the form of an oligomer with an average degree of oligomerization of n=3 to 6.

In a preferred embodiment the content of the derivative of the phosphinate acid in the composition is in the range from 5% to 45% by weight based on the total composition, in particular 7% to 30% by weight, more preferably in the range from 8% to 18% by weight, more preferably in the range from 10% to 15% by weight based on the weight of the whole composition.

In a preferred embodiment the aluminium diethylphosphinate has an average particle diameter D50 in the range between 20 μm and 80 μm, preferably between 20 μm and 40 μm.

### Melamine Polyphosphate

In a preferred embodiment 28 the composition according to one of the precedent embodiments or one of their preferred embodiments comprises melamine polyphosphate.

Preferably the melamine polyphosphate has a phosphorus content in the range from 7% to 20% by weight, preferably in the range from 10% to 17% by weight, more preferably in the range from 12% to 14% by weight, referring to the total weight of the melamine polyphosphate.

The melamine polyphosphate preferably consists of particles typically having an average particle diameter D50 in the range from 0.1 μm to 100 μm, preferably from 0.5 μm to 60 μm, particularly preferably 1 μm to 10 μm.

In a preferred embodiment 29 according to the precedent embodiment 28 or one of their preferred embodiments, the melamine polyphosphate is present in the composition in an amount between 2% and 35% by weight based on the total composition, in particular between 3% and 15% by weight, more preferably between 4% and 8% by weight.

In a preferred embodiment 30 the composition according to any of the precedent embodiments, or one of their preferred embodiments is free from melamine cyanurate. “Free from melamine cyanurate” preferably means that the composition comprises less than 5% by weight of melamine cyanurate, more preferably less than 1% by weight, more preferably less than 0.5% by weight, more preferably less than 0.01% by weight, more preferably less than 50 ppm, preferably less than 20 ppm. In a very preferred embodiment, the composition comprises 0 ppm of melamine cyanurate.

In a preferred embodiment 31 according to any of the precedent embodiments or one of their preferred embodiments, the flame retardant comprises a phosphinate, preferably diethyl aluminum phosphinate, and a derivative of the phosphoric acid as preferred above, most preferred resorcinol bis (diphenyl phosphate) (RDP), more preferred in the form of an oligomer with an average degree of oligomerization of n=3 to 6, and melamine polyphosphate as preferred above.

### Piperazine Pyrophosphate and Polypiperazine Pyrophosphate

In a preferred embodiment 32 according to one of the precedent embodiments, preferably according to embodiments 1 to 27, or one of their preferred embodiments the flame retardant comprises piperazine pyrophosphate or polypiperazine pyrophosphate, or a mixture thereof. In the context of the present invention, (poly) piperazine pyrophosphate used herein means a piperazine pyrophosphate represented by the following formula (I) or (II) or a mixture of the piperazine pyrophosphate represented by the formula (I) and poly (piperazine pyrophosphate) represented by the formula (II):

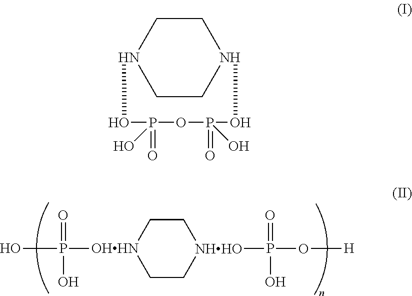

wherein n in formula (II) is an integer of 2 to 100.

Preferred is piperazine pyrophosphate.

Preferably the piperazine pyrophosphate or polypiperazine pyrophosphate consists of particles, preferably having an average particle diameter D98 in the range from 5 μm to 100 μm, more preferably from 10 μm to 90 μm, more preferably 20 μm to 80 μm, most preferably from 30 to 70 μm.

Preferably the piperazine pyrophosphate is present in the composition in an amount between 2% and 35% by weight based on the total composition, in particular between 3% and 15% by weight, more preferably between 4% and 8% by weight.

### Ammoniumpolyphosphate

In a preferred embodiment 32 according to one of the precedent embodiments, preferably according to on of the embodiments 1 to 27, or one of their preferred embodiments, the flame retardant comprises ammonium polyphosphate.

Preferred ammonium polyphosphates preferably, but not exclusively, are those found in J. Am. Chem. Soc. 91, 62 (1969), preferably those with crystal structure phase 1, or with crystal structure phase 2 or a mixture thereof.

Preferably, the ammonium polyphosphate has a number average molecular weight of more than 20×10³, preferably more than 80×10³, more preferably more than 1×10⁵. The average number average molecular weight of the ammonium polyphosphate preferably is between from 20×10³ and 1.5×10⁵.

In a preferred embodiment 33 according to the precedent embodiment 32 or one of their preferred embodiments the phosphate component is coated. The coating is at least partly. The coating of the phosphates results in compositions which have a low tendency of blooming.

Preferred coated ammonium polyphosphates are described in U.S. Pat. Nos. 4,347,334, 4,467,056, 4,514,328, and 4,639,331 herein incorporated by reference. Such encapsulated ammonium polyphosphates preferably comprise a hardened, water insoluble resin enveloping the individual ammonium polyphosphate particles. The resin preferably is based on urea resins, epoxy resins, or silanes.

A preferred coating is based on an organofunctional-silane or is a mixture thereof, or is based on an oligomeric organo-siloxane, or a mixture thereof. Preferred organofunctional silanes are alkoxysilanes with aminoalkyl-functionality, epoxyalkyl-, acryloxyalkyl-, methacryloxyalkyl-, mercaptoalkyl-, alkenyl-, or alkyl functionality, or a mixture thereof, wherein the alkoxy group preferably is a methoxy, an ethoxy or a propoxy group, or is a mixture thereof.

A particularly preferred organofunctional alkoxysilane is: 3-aminopropyltrialkoxysilane, 3-aminopropylmethyldialkoxysilane, 3-glycidyloxypropyltrialkoxysilane, 3-acryloxypropyltrialkoxysilane, 3-methacryloxypropyltrialkoxysilane, 3-mercaptopropyltrialkoxysilane, 3-mercaptopropylmethyldialkoxysilane, vinyltrialkoxysilane, vinyltris (2-methoxyethoxy) silane, propyltrialkoxysilane, butyltrialkoxysilane, pentyltrialkoxysilane, hexyltrialkoxysilane, heptyltrialkoxysilane, octyltrialkoxysilane, propylmethyldialkoxysilane and butylmethyldialkoxysilane, or a mixture thereof, wherein the alkoxy group preferably is a methoxy, an ethoxy or a propoxy group, or is a mixture thereof.

The coating preferably is applied in an amount of from 0.05% by weight to 10% by weight, particularly preferably from 0.1% by weight to 3% by weight, very particularly preferably from 0.5% by weight to 1.5% by weight, of silicon-containing coating agent, based on the amount of flame retardant.

Preferably the ammonium polyphosphate has a solubility in water of less than 1.0 g/l, in particular a solubility of less than 0.1 g/l. The solubility in water preferably is determined by shaking 50 g of the respective flame with 200 g of water for 1 hour at 20° C., filtering with a filter of 0.2 μm, drying the filter with the filtrate at 70° C. for 12 hours and determination of the filtrate.

The ammonium polyphosphate preferably consists of particles having an average particle diameter D50 between 0.1 μm and 100 μm, preferably between 0.5 μm and 60 μm, particularly preferably between 1 μm and 30 μm, very particularly preferably between 5 and 25 μm. Preferably the ammonium polyphosphates are a dry powder, more preferably a free-flowing powder.

In another preferred embodiment the particles preferably have an average particle diameter D99 of less than 100 μm, more preferably of less than 90 μm. In the context of the present invention the particles preferably have an average particle diameter D50 in the range from 0.1 μm to 100 μm and an average particle diameter D99 of less than 100 μm. Preferably the particle size distribution is monomodal or is multimodal, for example bimodal, or is a mixture thereof.

Preferably the ammonium polyphosphate is present in the composition in an amount between 2% and 35% by weight based on the total composition, in particular between 3% and 15% by weight, more preferably between 4% and 8% by weight.

### Preferred Combinations of Flame Retardants

In a preferred embodiment 34 of the composition according to one of the precedent embodiments, preferably according to one of the embodiments 1 to 27, or one of their preferred embodiments, the phosphorus containing flame retardant comprises a derivative of the phosphoric acid as preferred above as a first flame retardant F1, a derivative of the phosphinic acid as preferred above as a second flame retardant F2, and a third flame retardant F3 selected from melamine polyphosphate, piperazine pyrophosphate, polypiperazine pyrophosphate, ammonium polyphosphate, or a mixture thereof. A very preferred third flame retardant F3 is melamine polyphosphate. This is because it has a low water solubility.

In a preferred embodiment 35 of the composition according to one of the precedent embodiments, preferably according to one of the embodiments 1 to 27, or one of their preferred embodiments, the phosphorus containing flame retardant comprises as flame retardant F1 a derivative of the a phosphoric acid ester, preferably resorcinol bis (diphenyl phosphate) (RDP), diphenylkresylphosphat (DPK), or bisphenol A bis-(diphenylphosphate) (BDP), or a mixture thereof, as flame retardant F2 a derivative of the phosphinic acid, preferably a phosphinate with the formula: R1R2(P═O)O-Me wherein R1 and R2 are ethyl radicals and Me is aluminum, or zinc, and a third flame retardant F3, wherein the third flame retardant F2 is selected from melamine polyphosphate, piperazine pyrophosphate, polypiperazine pyrophosphate, ammonium phosphate, ammonium polyphosphate, or a mixture thereof. A preferred third flame retardant F3 is melamine polyphosphate.

In a preferred embodiment 36 of the composition according to one of the precedent embodiments, preferably according to one of the embodiments 1 to 27, or one of their preferred embodiments, the phosphorus containing flame retardant comprises as flame retardant F1 resorcinol bis (diphenyl phosphate) (RDP), as flame retardant F2 aluminiumdiethylphosphinate or aluminiumhypophosphit, or a mixture thereof, preferably aluminiumdiethylphosphinat, and as flame retardant F3 melamine polyphosphate.

In a preferred embodiment 37 of the composition according to one of the precedent embodiments, preferably according to one of the embodiments 1 to 27, or one of their preferred embodiments, the phosphorus containing flame retardant comprises as flame retardant F1 resorcinol bis (diphenyl phosphate) (RDP), as flame retardant F2 aluminiumdiethylphosphinate or aluminiumhypophosphit, or a mixture thereof, preferably aluminiumdiethylphosphinat, and as flame retardant F3 ammoniumpolyphosphate, as preferred in embodiments 32 to 33.

The composition in preferred embodiments comprises further flame retardants. Preferred nonphosphorus containing flame retardants preferably are selected from melamine cyanurate, metal hydroxide, or are a mixture thereof. If a non-phosphorus containing flame retardant is comprised in the composition the amount of the phosphorous containing flame retardant preferably is between 5 weight-% and 15 weight-%, referring to the whole composition.

In preferred embodiment 38 according to any of the precedent embodiments or one of their preferred embodiments, the total amount of all flame retardants is between 15 weight-% and 50 weight %, more preferably between 15 weight % and 35 weight %.

Preferably, the flame retardant has a water content of less than 1% by weight, more preferable of less than 0.5% by weight, in particular of less than 0.25% by weight.

In a preferred embodiment 39 according to any of the precedent embodiments or one of their preferred embodiments, the composition has a Shore hardness between 75 Shore A and 100 Shore A, more preferably between 80 Shore A and 95 Shore A, preferably measured according to DIN ISO 7619-1:2016

In a preferred embodiment 40 according to any of the precedent embodiments or one of their preferred embodiments the composition further comprises an aroma. Sometime the smell of the thermoplastic polyurethane, especially the composition further comprising additives or auxiliaries is found to be disturbing or even unbearable. This is often the case, when the thermoplastic polyurethane comprises substances like polystyrene, resorcinol bis (diphenyl phosphate) (RDP), diphenylkresylphosphat (DPK), bisphenol A bis-(diphenylphosphate) (BDP), or other derivates of kresol, phenol, resorcinol, or bisphenole A.

Preferably an aroma is a substance or a mixture of substances who's flavor diluted in ethanol to the concentration as used in the composition, preferably 0.01 weight % of the aroma in ethanol, is held to be agreeable of more than 50% of a group comprising an odd number of persons with at least 5 persons.

In a preferred embodiment 41 according to the precedent embodiment 40 the aroma is liquid at 20° C. In a preferred embodiment the aroma has a vapor pressure at 20° C. between 10 Pa and 180 Pa or a vapor pressure at 50° C. between 50 Pa and 1×10*3* Pa. The vapor pressure preferably is measured according to DIN EN 13016-1:2018 DE.

It was surprisingly found that aromas as preferred herein can compensate a disturbing or even unbearable smell of the composition respectively articles made from these compositions, even in very small amounts, and although the production process for thermoplastic polyurethane applies enormous heat.

In a preferred embodiment 42 according to the precedent embodiments 40 to 41 the aroma is comprised in an amount between 1×10⁻⁵ wt % and 1 wt % referring to the whole composition, more preferably between 5×10⁻⁴ wt % and 2×10⁻³ wt %. The whole composition is 100 wt %. Preferably the aroma is mixed with a polymer, preferably a thermoplastic polyurethane. This mixture, also referred to as aroma master batch, is used to bring the aroma into the composition. This premixing has the advantage that the low amount of aroma can better be distributed in the composition.

In a preferred embodiment 43 according to one of the precedent embodiments 40 to 42, or one of their preferred embodiments, the aroma is selected from ananas, anemone, anis, banana, flowers, lavandina, sugarcane, strawberry, pine, cacao, coffee, peanut, coconut, pineapple, green apple, pomegranate, mango, blueberry, apple, orange, lemon, lime, grapefruit, grape, vanilla sugarwatermelon, tomato, potato-chips, talc, avocado, or is a mixture thereof.

In a preferred embodiment 44 according to the precedent embodiment 40 to 43, the aroma is selected from flowers, lavandina, strawberry, green apple, pomegranate, vanilla sugar, talc, or is a mixture thereof. Most preferred the aroma comprises pomegranate.

In a preferred embodiment the aroma lavandina comprises at least one of the following aroma substances 2,6-dimethyloct-7-en-2-ol, terpineol, acetate, geraniol, 4-tert-butylcyclohexyl acetate, coumarin, linalyl acetate, Linalool, bornan-2-one, 1-(5,6,7,8-tetrahydro-3,5,5,6,8,8-hexamethyl-2-naphthyl) ethan-1-one, Octan-2-one, cineole, piperonal, P-mentha-1,4 (8)-diene, 5-cyclohexadecen-1-one, caryophyllene, d-limonene, Pin-2 (3)-ene, (−)-pin-2 (10)-ene, Neryl acetate, or is a mixture thereof. More preferred, the mixture comprises 1, 2,3, 4, 5, 6, 7, 8, 9, 10, 11, 12, 13, 14, 15, 16, 17, 18 or 19 of these aroma substances.

In a preferred embodiment the aroma strawberry comprises at least one of the following aroma substances: 2,2,4,6,6-pentamethylheptane, benzyl alcohol, Ethyl 2,3-epoxy-3-phenylbutyrate, 1,3,4,6,7,8-hexahydro-4,6,6,7,8,8-hexamethylindeno[5,6-c]pyran, 2-phenylethanol, d-limonene, Phenethyl acetate, Tricyclodecanedimethanol, Isopentyl acetate, Ethyl butyrate, Allyl heptanoate, Linalool, Hexyl salicylate, (E)-anethole, 2,4-dimethylcyclohex-3-ene-1-carbaldehyde, Damascenone, Toluene, or is a mixture thereof. More preferred, the mixture comprises 1, 2,3, 4, 5, 6, 7, 8, 9, 10, 11, 12, 13, 14, 15, 16, or 17 of these aroma substances.

In a preferred embodiment the aroma green apple comprises at least one of the following aroma substances: 2,2,4,6,6-pentamethylheptane, cis-2-tert-butylcyclohexyl acetate, 2,6-dimethyloct-7-en-2-ol, Undecan-4-olide, Ethyl hexanoate, Isopentyl acetate, Reaction mass of allyl (2-methylbutoxy) acetate and allyl (3-methylbutoxy) acetate, Ethyl butyrate, Hexanal, ethyl 2-naphthyl ether, Methyl cinnamate, 2,4-dimethylcyclohex-3-ene-1-carbaldehyde, 2,4-dimethylcyclohex-3-ene-1-carbaldehyde, Trans-hex-2-enal, 3,5-dimethylcyclohex-3-ene-1-carbaldehyde, or is a mixture thereof. More preferred, the mixture comprises 1, 2,3, 4, 5, 6, 7, 8, 9, 10, 11, 12, 13, or 14 of these aroma substances.

In a preferred embodiment the aroma pomegranate comprises at least one of the following aroma substances: 2,2,4,6,6-pentamethylheptane, 3-methoxy-3-methylbutan-1-ol, Diethyl malonate, Tetrahydro-2-isobutyl-4-methylpyran-4-ol, mixed isomers (cis and trans), Benzyl acetate, cis-2-tert-butylcyclohexyl acetate, 2,6-dimethyloct-7-en-2-ol, d-limonene, (E)-4-(2,6,6-trimethyl-1-cyclohexen-1-yl)-3-buten-2-one, Linalool, Linalyl acetate, a-methyl-1,3-benzodioxole-5-propionaldehyde, a, a-dimethylphenethyl butyrate, Ethyl octanoate, Undecan-4-olide, Ethyl 2,3-epoxy-3-phenylbutyrate, Ethyl 2-naphthyl ethe, Diphenyl ether, reaction mass of cis-4-(isopropyl) cyclohexanemethanol and trans-4-(isopropyl) cyclohexanemethanol, 1-(2,6,6-trimethyl-3-cyclohexen-1-yl)-2-buten-1-one, 3-(p-cumenyl)-2-methylpropionaldehyde, Toluene, or is a mixture thereof. More preferred, the mixture comprises 1, 2,3, 4, 5, 6, 7, 8, 9, 10, 11, 12, 13, 14, 15, 16, 17, 18, 19, 20,21, or 22 of these aroma substances.

In a preferred embodiment the aroma vanilla comprises at least one of the following aroma substances: 2,2,4,6,6-pentamethylheptane, 2,2,4,6,6-pentamethylheptane, 3-ethoxy-4-hydroxybenzaldehyde, Vanillin, Resin acids and Rosin acids, hydrogenated, Me esters, Linalool, 3-(2,2-dimethyl-3-hydroxypropyl) toluene, 3-(p-cumenyl) propionaldehyde, Reaction mass of cis-4-(isopropyl) cyclohexanemethanol and trans-4-(isopropyl) cyclohexanemethanol, 3-p-cumenyl-2-methylpropionaldehyde, or is a mixture thereof. More preferred, the mixture comprises 1, 2,3, 4, 5, 6, 7, 8 or, 9, of these aroma substances.

In a preferred embodiment the aroma talc comprises at least one of the following aroma substances: 2,2,4,6,6-pentamethylheptane, Benzyl benzoate, Coumarin, Citronellyl acetate, 3-Methyl-4-(2,6,6-trimethyl-2-cyclohexen-1-yl)-3-buten-2-one, Cinnamyl alcohol, (E)-4-(2,6,6-trimethyl-1-cyclohexen-1-yl)-3-buten-2-one, Benzyl acetate, Terpineol, acetate, reaction mass of: (E)oxacyclohexadec-12-en-2-one, Octan-4-olide, veratraldehyde, neryl acetate, hexyl salicylate, linalool, 1,3,4,6,7,8-hexahydro-4,6,6,7,8,8-hexamethylindeno[5,6-c]pyran, Reaction mass of 2-methylbutyl salicylate and pentyl salicylate, 4-methylanisole, P-mentha-1,4 (8)-diene, Isoeugenol, Toluene, or is a mixture thereof. More preferred, the mixture comprises 1, 2,3, 4, 5, 6, 7, 8, 9, 10, 11, 12, 13, 14, 15, 16, 17, 18, 19, 20, or 21 of these aroma substances.

In a preferred embodiment the aroma talc comprises at least one of the following aroma substances: Linalyl acetate, 2,6-dimethyloct-7-en-2-ol, 3,7-dimethyloctan-3-ol, cis-2-tert-butylcyclohexyl acetate, 2-acetoxy-2,3,8,8-tetramethyloctahydronaphthalene, [1aS-(1aα,4aβ,8aR*)]-1,1a,4,4a,5,6,7,8-octahydro-2,4a,8,8-tetramethylcyclopropa[d]naphthalene, Cedryl methyl ketone, Tetrahydro-2-isobutyl-4-methylpyran-4-ol, mixed isomers (cis and trans), Cineole, 2,6-ditert-butyl-p-cresol, 1-(5,6,7,8-tetrahydro-3,5,5,6,8,8-hexamethyl-2-naphthyl) ethan-1-one, Nerolidol, d-limonene, Alpha-cedrene, [3R-(3α,3aβ,7β,8aα)]-octahydro-3,8,8-trimethyl-6-methylene-1H-3a,7-methanoazulene, Geraniol, Reaction mass of allyl (2-methylbutoxy) acetate and allyl (3-methylbutoxy) acetate, p-mentha-1,4-diene, Reaction mass of (2E)-Tridec-2-enenitrile and (2Z)-Tridec-2-enenitrile and (3E)-Tridec-3-enenitrile and (3Z)-Tridec-3-enenitrile, [1s(1α,3aβ,4α,8aβ)]-decahydro-4,8,8-trimethyl-9-methylene-1,4-methanoazulene, or is a mixture thereof. More preferred, the mixture comprises 1, 2, 3, 4, 5, 6, 7, 8, 9, 10, 11, 12, 13, 14, 15, 16, 17, 18, 19, or 20 of these aroma substances.

### Production Process

Another aspect of the invention and embodiment 45 is the production process of the composition comprising a thermoplastic polyurethane according to any of the precedent embodiments 1 to 44, or one their preferred embodiments.

Preferably the production process is discontinuously or continuously. A preferred production process is the reaction extruder process, the belt line process, or the “one shot” process, preferably the “one-shot” process or the reaction extruder process, most preferably the reaction extruder process.

These processes are used either by directly mixing the building components or alternatively by applying the prepolymer process.

Polyisocyanate prepolymers are obtainable by reacting polyisocyanate as preferred in embodiments 2 to 4 in excess, at temperatures of 30° C. to 100° C., preferably at 8×10° C., with the polyol.

In the “one-shot” process, the building components diisocyanate, the polyol, and the chain extender, are mixed with each other. This is done either in succession or simultaneously, in a preferred embodiment in the presence of a catalyst. In the extruder process, the building components diisocyanate, polyol, and chain extender, and, in further preferred embodiments, also the catalyst are mixed. The mixing in the reaction extruding process is done preferably at temperatures between 100° C. and 280° C., more preferably between 140° C. and 250° C. The thermoplastic polyurethane obtained, preferably is in the form of a granulate or a powder. Auxiliaries and additives may be added during the synthesis of the thermoplastic polyurethane or are added to the thermoplastic polyurethane. The latter is preferred. This is especially the case, if the additive or auxiliary is not inert against the isocyanate, the chain extender, the compound reactive with isocyanate, or the catalyst. The polystyrene is mixed with the thermoplastic polyurethane, eventually further comprising the catalyst, an auxiliary, or an additive, or a mixture thereof to become the composition.

In a preferred embodiment the synthesis of the thermoplastic polyurethane takes place in an extruder, more preferably a twin-screw extruder is used. The twin-screw extruder operates with positive conveying and thus allows a more precise setting of the temperature and output quantity on the extruder.

In a preferred embodiment the composition is produced by processing the thermoplastic polyurethane, the polystyrene and the flame retardants in one step. In another preferred embodiment the thermoplastic polyurethane is produced by in a first step using a reaction extruder, a belt assembly or other suitable apparatus to produce a thermoplastic polyurethane, preferably as a granulate, into which the polystyrene and the phosphorus containing flame retardant, and, if applicable, further additives or auxiliaries, and the aroma are then introduced in at least one further step, or else in a plurality of steps to arrive at the composition.

The mixing of the thermoplastic polyurethane with the other components preferably takes place in a mixing unit, preferably a kneader or an extruder, more preferably a twin-screw extruder. In a preferred embodiment the flame retardant introduced into the mixing unit in the at least one further step is liquid, preferably liquid at a temperature of 21° C. In another preferred embodiment the flame retardant is at liquid at a temperature prevailing downstream of the filling point in the flow direction of the material in the extruder.

### Pellet/Powder

In a preferred embodiment 46 the thermoplastic polyurethane composition according to one of embodiments 1 to 44 or its preferred embodiments, respectively the composition derived by the process according to embodiment 45 or one of their preferred embodiments is in the form of a pellet or a powder. The pellet or powder in a preferred embodiment is a compact material. In another preferred embodiment the pellet is expanded material, also referred to as foamed beads or foamed powder. Beads respectively expanded beads in a preferred embodiment refers to particles with a maximal extension between 1 mm and 5 cm. Powder in a preferred embodiment refers to particles with a maximum size of 1 mm. Preferably the size of the powder is between 1×10⁻⁶ m and 1 mm.

Another aspect and embodiment 47 of this invention therefore is a foamed bead or a foamed particle made of the composition according to one of embodiments 1 to 44 or on of their preferred embodiments, or as obtained according to embodiments 45 or one of their preferred embodiments.

The foamed beads and also molded bodies produced therefrom may be used in various applications (see e.g. WO 94/20568, WO 2007/082838 A1, WO2017030835, WO 2013/153190 A1, WO2010010010), herein incorporated by reference

The composition respectively the pellets, powder or foamed beads achieved according to one of the embodiments in a preferred embodiment is moulded, injection moulded, calendered, powder sintered, or extruded to form an article.

### Article

Another aspect of the invention and embodiment 48 is the article produced with a composition according to one of embodiments 1 to 44 or its preferred embodiments, respectively derived from a pellet or powder according to embodiments 46 or 47 or one of their preferred embodiments, or as obtained by the process according to embodiment 45 or one of its preferred embodiments.

Preferably the article is selected from the group consisting of cable, cases, cell-phone, coating, covers, damping element, bellows, foil, fiber, film, moulded body, roofing or flooring for buildings or vehicles, non-woven fabric, gasket, packaging material, roll, shoe sole, middle sole of a shoe, hose, cable, cable connector, cable sheathing, pillow, laminate, phone, profile, strap, saddle, foam, by additional foaming of the preparation, plug connection, television, trailing cable, solar module, lining in automobiles, wiper blade, elevator load bearing members, roping arrangements, drive belts for machines, preferably passenger conveyer, handrails for passenger conveyers modifier for thermoplastic materials, which means substance that influences the properties of another material. Each of these articles itself is a preferred embodiment, also referred to as an application.

More preferably the product is selected from covers, packaging material, cases, phone, cell phones, television, or cable, more preferably for electronic device.

A preferred embodiment 49 according to the embodiment 48 is a cable comprising a composition according any of the precedent embodiments 1 to 44 or one of their preferred embodiments.

In a preferred embodiment 50 according to the precedent embodiment 49 the cable is a charging cable for a craft, more preferably a vehicle.

### Use for Producing an Article

Another aspect of the invention and embodiment 51 is the use of the composition according to one of the embodiments 1 to 44 or its preferred embodiments, or as obtained according to embodiment 45 or one of its preferred embodiments for producing an article.

The present invention is further illustrated by the following set of embodiments and combinations of embodiments resulting from the dependencies and back-references as indicated and it is explicitly noted that the following set of embodiments is not the set of claims determining the extent of protection but represents a suitably structured part of the description directed to general and preferred aspects of the present invention.

### EXAMPLES

### 1. Example—Raw Materials

Elastollan A: TPU of Shore hardness 85A of BASF Polyurethanes GmbH, Elastogranstrasse 60, 49448 Lemförde, based on polytetrahydrofuranpolyole (PTHF) with a molweight Mn 1000 g/mol, 1,4-butandiole, diphenylmethan-4,4′-diisocyanat.

Elastollan B: TPU of Shore hardness 85A of BASF Polyurethanes GmbH, Elastogranstrasse 60, 49448 Lemförde, based on a mixture of polytetrahydrofuranpolyole (PTHF) with a molweight Mn 1000 g/mol (425 weight parts) und polytetrahydrofuranpolyole (PTHF) with a molweight Mn 2000 g/mol (575 weight parts), 1,4-butandiole, diphenylmethan-4,4′-diisocyanat.

Styrolution PS 485N, CAS #: 9003-55-8, Polymer (C₈H₈C₄H₆)ₓ, Styrol-Butadien Copolymer, HIPS, INEOS Styrolution Group GmbH, Mainzer Landstraße 50, DE-60325 Frankfurt, Melt Volume Rate, 200° C./5 kg (ISO 1133): 4 cm³/10 min.

Melapur 200/70: Melaminpolyphosphat (nitrogen content 42-44 wt %, phosphorous content 12-14 wt %)), CAS #: 218768-84-4, BASF SE, 67056 Ludwigshafen, GERMANY, Partikelgröße D99%</=70 μm, mittlerer Teilchendurchmesser D50%<=10 μm, Wassergehalt % (w/w)<0.3.

Fyrolflex RDP: Resorcinol bis (diphenyl phosphat), CAS #: 125997-21-9, Supresta Netherlands B.V., Office Park De Hoef, Hoefseweg 1, 3821 AE Amersfoort, The Netherlands, viscosity at 25° C.=700 mPas, acid number <0.1 mg KOH/g, water content % (w/w)<0,1.

Melapur MC 15 ED: Melamincyanurat (1,3,5-Triazin-2,4,6 (1H,3H,5H)-trion, salt with 1,3,5-Triazin-2,4,6-triamin (1:1)), CAS #: 37640-57-6, BASF SE, 67056 Ludwigshafen, GERMANY, particle size D99%</=50 μm, D50%<=4.5 μm, water content % (w/w)<0.2.

Exolit OP 1230: Aluminiumdiethylphosphinat, CAS #: 225789-38-8, Clariant Produkte (Deutschland) GmbH, Chemiepark Knapsack, 50351 Hürth, water content % (w/w)<0,2, particle size D99%</=90 μm, average particle diameter D50=20-40 μm.

PR26234: Fragrance, Light Blue Lavandina 2516 Mod.I, Industrie Chimiche Muller & Koster S.p.A., Via Papa Giovanni XXIII 12, 20050 Liscate—Milano—Italia.

PR27785: Fragrance, Strawberry 844/3958 Plast, Industrie Chimiche Muller & Koster S.p.A., Via Papa Giovanni XXIII 12, 20050 Liscate—Milano—Italia.

PR27867: Fragrance, Green Apple R 5077 SSA-Plast, Industrie Chimiche Muller & Koster S.p.A., Via Papa Giovanni XXIII 12, 20050 Liscate—Milano—Italia.

PR30367: Fragrance, Pomegranate R 5240 Plast, Industrie Chimiche Muller & Koster S.p.A., Via Papa Giovanni XXIII 12, 20050 Liscate—Milano—Italia.

PR31753: Fragrance, Vanilla Sugar R 5098 Plast, Industrie Chimiche Muller & Koster S.p.A., Via Papa Giovanni XXIII 12, 20050 Liscate—Milano—Italia.

PR37816: Fragrance, Flowers V 6509, Industrie Chimiche Muller & Koster S.p.A., Via Papa Giovanni XXIII 12, 20050 Liscate—Milano—Italia.

### 2. Example—Production of the Composition

The Tables 1a and 1b list compositions in which the individual ingredients are denoted in parts per weight (pbw). The composition in each case were produced with a Berstorff ZE 40 A twinscrew extruder with a 35 D screw, divided into 10 barrels. Granules were obtained using an underwater pelletizing unit of Gala.

All thermoplastic polyurethanes employed have an average molecular weight of more than 150.000 Da.

TABLE 1a

| | 1 (CE) | 2 (CE) | 3 (IE) | 4 (IE) | 5 (IE) |
|---|---|---|---|---|---|
| Elastollan A | 64 | 75.5 | 65 | 70.5 | |
| Elastollan B | | | | | 70.5 |
| Styrolution PS 485N | | | 10 | 6.5 | 6.5 |
| Exolit OP 1230 | | 15 | 10 | 12.5 | 12.5 |
| Fyrolflex RDP | 6 | 2 | 10 | 4 | 4 |
| Melapur 200/70 | | 7.5 | 5 | 6.5 | 6.5 |
| Melapur MC 15 ED | 30 | | | | |

For all tables:
IE = inventive example,
CE = comparative example

TABLE 1b

| | 6 (IE) | 7 (IE) | 8 (IE) | 9 (IE) | 10 (IE) | 11 (IE) |
|---|---|---|---|---|---|---|
| Elastollan B | 70.49 | 70.49 | 70.49 | 70.49 | 70.49 | 70.49 |
| Styrolution PS 485N | 6.5 | 6.5 | 6.5 | 6.5 | 6.5 | 6.5 |
| Exolit OP 1230 | 12.5 | 12.5 | 12.5 | 12.5 | 12.5 | 12.5 |
| Fyrolflex RDP | 4 | 4 | 4 | 4 | 4 | 4 |
| Melapur 200/70 | 6.5 | 6.5 | 6.5 | 6.5 | 6.5 | 6.5 |
| Light Blue Lavandina 2516 Mod. I | 0.01 | | | | | |
| Strawberry 844/3958 Plast | | 0.01 | | | | |
| Green Apple R 5077 SSA-Plast | | | 0.01 | | | |
| Pomegranate R 5240 Plast | | | | 0.01 | | |
| Vanilla Sugar R 5098 Plast | | | | | 0.01 | |
| Flowers V 6509 | | | | | | 0.01 |

### 3. Example—Measurement of Flame Retardancy and Surface Properties

To evaluate flame retardancy, a test specimen of thickness 5 mm from the respective composition is tested horizontally with radiation of intensity 35 kW/m² in a cone calorimeter in accordance with ISO 5660 part 1 and part 2 (2002-12). The test specimens for the cone measurements with dimensions 100×100×5 mm were injection molded using an Arburg 520S with screw diameter 30 mm. The key parameters for the cone measurements for the different materials are given in Table 2a and Table 2b. The inventive examples (IE) show similar total heat release (THE) and peak of heat release (PHRR) in comparison to the comparative examples (CE).

TABLE 2a

| | | 1 (CE) | 2 (CE) | 3 (IE) | 4 (IE) | 5 (IE) |
|---|---|---|---|---|---|---|
| Total Heat Release (THR) | [MJ/m²] | 140 | 138 | 130 | 134 | 135 |
| Peak of heat release (PHRR) | [kW/m²] | 400 | 366 | 320 | 340 | 335 |

TABLE 2b

| | | 6 (IE) | 7 (IE) | 8 (IE) | 9 (IE) | 10(IE) | 11 (IE) |
|---|---|---|---|---|---|---|---|
| Total Heat Release (THR) | [MJ/m²] | 135 | 135 | 133 | 137 | 136 | ′134 |
| Peak of heat release (PHRR) | [kW/m²] | 330 | 340 | 340 | 345 | 335 | 342 |

To further assessing the flame retardancy a conventional extrusion line (smooth tube extruder, diameter 45 mm) for cable sheathing was used to produce cables, a conventional three-zone screw with a compression ratio of 2.5:1 was employed.

The compositions were dried for 5 h at 120° C. before extrusion. The following temperature profile was employed: zone 1 to zone 6: 195/200/205/210/215/215° C.

Three insulated cores with a copper cross section of 2.5 mm² and one insulated core with a copper cross section of 0.5 mm² were stranded and a sheath (sheath thickness 1.5-3.1 mm, outer diameter 10 mm) was applied by extrusion by the pressure extrusion method.

The cable surfaces of comparative example (CE) 1 and the inventive examples (IE) 3-11 appear mat. The cable surface of comparative example 2 appears shiny. Matt surfaces are more desirable—they appear scratch resistant and visually appealing.

An IEC60332 flame test was performed on these cables. The test was performed on 3 cables in each case. The results are summarized in Table 3.

TABLE 3

| | |
|---|---|
| Composition | Flame test (IEC60332) * |

| | | |
|---|---|---|
| 1 | (CE) | 3/3 |
| 2 | (CE) | 3/3 |
| 3 | (IE) | 3/3 |
| 4 | (IE) | 3/3 |
| 5 | (IE) | 3/3 |
| 6 | (IE) | 3/3 |
| 7 | (IE) | 3/3 |
| 8 | (IE) | 3/3 |
| 9 | (IE) | 3/3 |
| 10 | (IE) | 3/3 |
| 11 | (IE) | 3/3 |

* Number of test performed/number of tests passed.
The results show that all examples have very good flame retardancy properties.

### 4. Example—Conductivity of the Smoke Gases

The conductivities determined using DIN EN 60754-2 (2015) were found to be low for the inventive examples compared to comparative example 1, which contains melamine cyanurate. The inventive mixtures appear to be much less corrosive compared to the comparative example composition 1. The results are given in Table 4a and Table 4b.

TABLE 4a

| | | | 1 (CE) | 2 (CE) | 3 (IE) | 4 (IE) | 5 (IE) |
|---|---|---|---|---|---|---|---|
| pH - value | | DIN EN 60754-2 (2015) | 9.2 | 8.8 | 7.8 | 8.0 | 8.2 |
| conductivity | [μS/mm] | DIN EN 60754-2 (2015) | 53 | 24 | 15 | 17 | 18 |

TABLE 4b

| | | | 6 (IE) | 7 (IE) | 8 (IE) | 9 (IE) | 10 (IE) | 11 (IE) |
|---|---|---|---|---|---|---|---|---|
| pH - value | | DIN EN 60754-2 (2015) | 7.9 | 8.0 | 8.0 | 7.9 | 8.0 | 8.1 |
| conductivity | [μS/mm] | DIN EN 60754-2 (2015) | 16 | 18 | 19 | 17 | 17 | 16 |

### 5. Example—Mechanical Properties and Surface Finish

The compositions were extruded with an Arenz single-screw extruder having a three-zone screw with a mixing section (screw ratio 1:3) to give films having a thickness of 1.6 mm.

The compositions were dried for 5 h at 120° C. before extrusion. The following temperature profile was employed: zone 1 to zone 6: 195/200/205/210/215/215° C.

Density, Shore hardness, tensile strength, tear propagation resistance, abrasion, and elongation at break of the corresponding test specimens were measured. All compositions have good mechanical properties. The results are listed in Table 5a and 5b.

The film surfaces of comparative example 1 and the inventive examples 3-11 appear mat. The cable surface of comparative example 2 appears shiny. Matt surfaces are desirable—they appear scratch resistant visually appealing.

TABLE 5a

| | 1 (CE) | 2 (CE) | 3 (IE) | 4 (IE) | 5 (IE) |
|---|---|---|---|---|---|
| MFI | 35 | 20 | 40 | 70 | 60 |
| [g/10 min] | | | | | |
| 200° C., 21.6 Kg | | | | | |
| Density [g/cm³] | 1.25 | 1.18 | 1.17 | 1.18 | 1.18 |
| Shore hardness [A] | 90 | 88 | 87 | 86 | 86 |
| Tensile strength [MPa] | 26 | 36 | 31 | 28 | 24 |
| Elongation at break [%] | 500 | 500 | 490 | 560 | 610 |
| Tear strength [kN/m] | 55 | 53 | 43 | 49 | 50 |
| Abrasion [mm³] | 35 | 60 | 72 | 94 | 110 |

TABLE 5b

| | 6 (IE) | 7 (IE) | 8 (IE) | 9 (IE) | 10 (IE) | 11 (IE) |
|---|---|---|---|---|---|---|
| MFI | 61 | 60 | 63 | 58 | 60 | 60 |
| [g/10 min] | | | | | | |
| 200° C., 21.6 Kg | | | | | | |
| Density [g/cm³] | 1.18 | 1.18 | 1.18 | 1.18 | 1.18 | 1.18 |
| Shore hardness [A] | 86 | 86 | 86 | 86 | 86 | 86 |
| Tensile strength [MPa] | 23 | 24 | 25 | 22 | 22 | 23 |
| Elongation at break [%] | 600 | 590 | 580 | 600 | 590 | 580 |
| Tear strength [kN/m] | 49 | 50 | 51 | 50 | 50 | 49 |
| Abrasion [mm³] | 111 | 108 | 105 | 104 | 110 | 110 |

### 6. Example—Low Temperature Properties

To evaluate the low temperature properties a dynamical mechanical analysis was performed (DMA, ISO 6721-2, frequency 1 Hz). The glass temperatures of the different materials (Max G″) are given in Table 6. The inventive example 5 has a significant lower glass temperature than the other materials.

TABLE 6

| | 1 (CE) | 2 (CE) | 3 (IE) | 4 (IE) | 5 (IE) |
|---|---|---|---|---|---|
| G″ from DMA [° C.] | −40 | −40 | −40 | −40 | −55 |

### 7. Example—Smell

The smell of the different materials was evaluated using VW PV 3900 (2019-04). The materials (25 g) were given in a 11 test vessel and stored for 2 h at 80° C. Then an odor assessment was performed. Hereby the following grades were used. The average of the grades given by 5 test persons is given in Table 7a and 7b.
1—Imperceptible
2—Perceptible, not disturbing
3—Distinctly perceptible, not disturbing
4—Disturbing
5—Strongly disturbing
6—unbearable

TABLE 7a

| | | 1 (CE) | 2 (IE) | 3 (IE) | 4 (IE) | 5 (IE) |
|---|---|---|---|---|---|---|
| Grade | VW PV 3900 (2019-04) | 3.3 | 2.8 | 5.2 | 3.8 | 3.6 |

TABLE 7b

| | | 6 (IE) | 7 (IE) | 8 (IE) | 9 (IE) | 10 (IE) | 11 (IE) |
|---|---|---|---|---|---|---|---|
| Grade | VW PV 3900 (2019-04) | 2.3 | 2.1 | 2.5 | 2.2 | 2.3 | 2.2 |

### 8. Example—Methods

Density: DIN EN ISO 1183-1, A
Shore hardness A: DIN ISO 7619-1, Shore A (3s)
Tensile strength: DIN EN ISO 527
Elongation at break: DIN EN ISO 527
Tear strength: DIN ISO 34-1, B (b
Abrasion: DIN 53516
Cone calorimeter test: ISO 5660 part 1 and part 2 (2002-12)
Smell: VW PV 3900 (2019-04)

### 9. Summary

Table 8 shows the different properties of the different examples. All examples have a very good flame retardancy, but only the inventive examples 3-11 combine matte finish and low conductivity of smoke gases. Inventive examples 4-11 have compared to inventive example 3 a much better smell. Inventive examples 5-11 have compared to inventive examples 3-4 a better cold flexibility. Inventive examples 6-11 have a better smell than the inventive examples 3-5.

TABLE 8

| | 1 (CE) | 2 (CE) | 3 (IE) | 4 (IE) | 5 (IE) |
|---|---|---|---|---|---|
| Flame retardancy | +++ | +++ | +++ | +++ | +++ |
| Surface apearance | matte | shiny | matte | matte | matte |
| conductivity of smoke gases *) | to high | low | low | low | low |
| smell (grade) | 3.3 | 2.8 | 5.2 | 3.8 | 3.6 |
| cold flexibility | −40 | −40 | −40 | −40 | −55 |
| G″ from DMA [° C.] | | | | | |

*) DIN EN 60754-2 2015

1. A thermoplastic polyurethane composition, comprising:
a thermoplastic polyurethane;
a polystyrene; and
a phosphorus-containing flame retardant;
wherein:
the thermoplastic polyurethane is a reaction product of at least:
a) an isocyanate;
b) a polyol; and
c) a chain extender; and
the polystyrene is present in an amount of 0.5 wt % to 15 wt % based on a total weight of the composition.

2. The composition according to claim 1, wherein the phosphorus-containing flame retardant comprises a derivative of phosphorus acid, phosphonic acid, or phosphinic acid, or a mixture thereof.

3. The composition according to claim 1, comprising a derivative of cresol, phenol, resorcinol, or bisphenol A, or a mixture thereof.

4. The composition according to claim 1, wherein the phosphorus containing flame retardant comprises a phosphoric acid ester.

5. The composition according to claim 1, wherein the phosphorus-containing flame retardant is present in an amount of 10 wt % to 30 wt % based on the total weight of the composition.

6. The composition according to claim 1, wherein the polystyrene is present in an amount of 0.5 wt % to 7 wt % based on the total weight of the composition.

7. The composition according to claim 1, wherein the polyol comprises a polyether polyol.

8. The composition according to claim 1, wherein the polyol has a number average molecular weight according to DIN 55672-1:2016-03 of 0.6×10³ g/mol to 2.0×10³ g/mol.

9. The composition according to claim 1, wherein the composition has a Shore hardness of 75 A to 100 A.

10. The composition according to claim 1, comprising an aroma.

11. The composition according to claim 10, wherein the aroma is liquid at 20° C.

12. The composition according to claim 1, comprising an aroma in an amount of 1×10⁻⁴ wt % to 1 wt % based on the total weight of the composition.

13. A cable, comprising the composition according to claim 1.

14. The cable according to claim 13, wherein the cable is a charging cable for a craft.

15. The composition according to claim 1, wherein the polyol comprises at least one polyol selected from the group consisting of a poly propanediol, a poly butanediol, a poly pentanediol, and a polyhexane diol.

16. The composition according to claim 1, wherein the composition has a Shore hardness of 80 A to 95 A.

17. The composition according to claim 1, comprising an aroma in an amount of 2×10⁻³ wt % to 5×10⁻³ wt % based on the total weight of the composition.

18. The cable according to claim 13, wherein the cable is a charging cable for a vehicle.
